(19) United States
(12) Patent Application Publication
(10) Pub. No.: US 2009/0084562 A1
(43) Pub. Date: Apr. 2, 2009

(54) Filtered Cake Candle Extinguisher

(76) Inventor: Jacqueline A. GATLING, Marlton, NJ (US)

Correspondence Address: MYERS WOLIN, LLC, 100 HEADQUARTERS PLAZA, North Tower, 6th Floor, MORRISTOWN, NJ, 07960-6834, US

(21) Appl. No.: 12/238,971

(22) Filed: Sep. 26, 2008

Related U.S. Application Data
(60) Provisional application No. 60/976,443, filed on Sep. 30, 2007.

(51) Int. Cl. A62C 39/00

(52) U.S. Cl. 169/91

(57) ABSTRACT

A filtered cake candle extinguisher device comprises a filter, a mouthpiece connected to the filter and a decorative cover for covering filter. A sound generator may be provided to enhance the user's enjoyment while using the extinguisher device to blow out a candle or candles.

### CROSS-REFERENCE TO RELATED APPLICATIONS

This application claims the benefit of U.S. Provisional Application No. 60/976,443 filed on Sep. 30, 2007, the contents of which are herein incorporated by reference.

### FIELD OF THE INVENTION

The present invention relates to a device for blowing out candles on a birthday cake generally, and more particularly to an economical, effective, easy to use new filtering device for blowing out candles on a birthday cake while minimizing the spread of germs.

### BACKGROUND

Birthday, holiday and occasion cakes are often decorated with designs with a particular motif or theme to commemorate a particular event. The cakes are meant to be visually pleasing and protected until the cake is sliced for serving. Candles are frequently placed on cakes to help commemorate the event being celebrated. After the candles are lit, by a match or other means, the person or persons who are involved in the commemoration are then asked to blow the candle or candles out to extinguish the same.

To some, the act of blowing out the candles raises concerns about the transmission of germs, particularly if the birthday boy or girl is sick. With one forceful blow, a sick individual can contaminate an entire cake. There is a need, therefore, for a device or the like for blowing out candles on a cake without jeopardizing the health of the participants and future consumers of the cake.

### SUMMARY

A filtered cake candle extinguisher device comprises a filter, a mouthpiece connected to the filter and a decorative cover for covering filter. A user blows into the mouthpiece and through the filter so that the air that contacts the cake and the candles is filtered to prevent the spread of the user's germs and the ultimate contamination of the cake. A sound generator may be provided in conjunction with the filter to enhance the user's enjoyment while using the extinguisher device to blow out the candles.

### BRIEF DESCRIPTION OF THE DRAWINGS

FIG. 1 is one embodiment of a filtered cake candle extinguisher device of the present invention.

FIG. 2 is an exploded view of the device of FIG. 1.

FIG. 3 illustrates use of the device of FIG. 1.

FIGS. 4-9 are alternative embodiments of the device of FIG. 1.

### DETAILED DESCRIPTION OF THE PREFERRED EMBODIMENTS

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

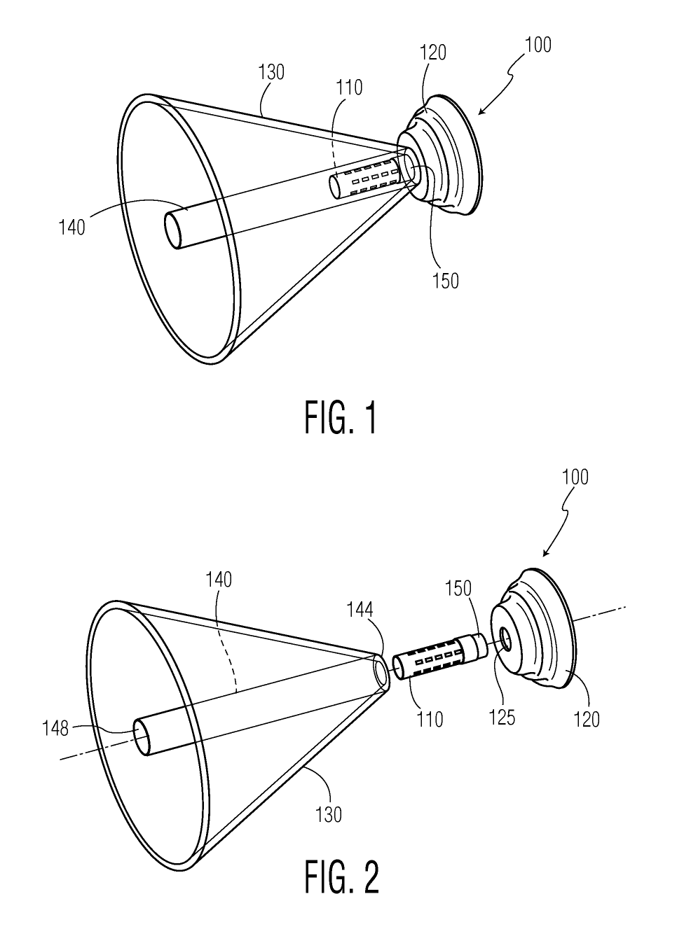

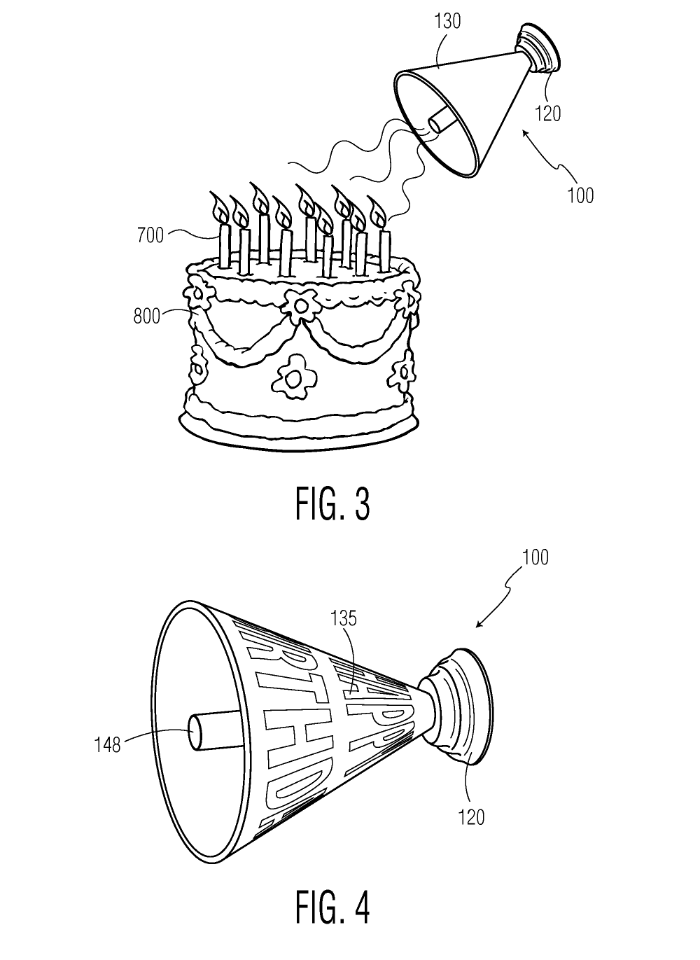

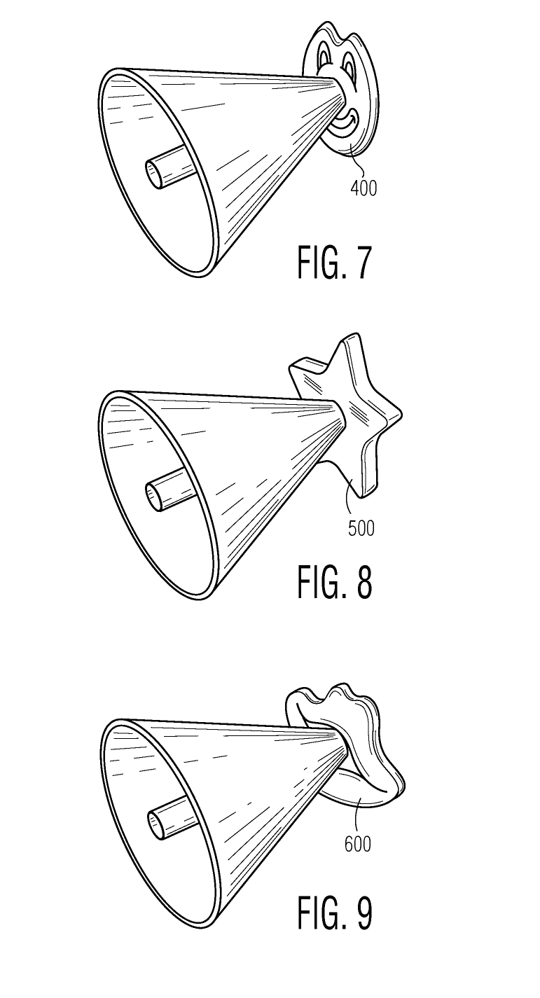

FIGS. 1 and 2 illustrate one embodiment of a filtered cake candle extinguisher device 100 of the present invention, hereafter referred to as extinguisher 100. Extinguisher 100 further preferably comprises a filter 110, a mouthpiece 120 with an opening 125 that is connected to the filter 110, and a decorative cover 130 for covering at least a portion of the filter 110. The decorative cover 130 is preferably formed in the shape of a cone, although other shapes are contemplated such as, but not limited to a flower 200 (FIG. 5) or a musical instrument 300 (FIG. 6). The decorative cover 130 is preferably further adorned with a message 135 (FIG. 4) that is indicative of a particular theme or occasion, such as a birthday, wedding, graduation, etc. Similarly, the mouthpiece 120 can have a variety of designs such as, but not limited to, a face 400 (FIG. 7), a star 500 (FIG. 8), or lips 600 (FIG. 9). Other designs, shapes and themes are contemplated to accommodate a variety of potential uses.

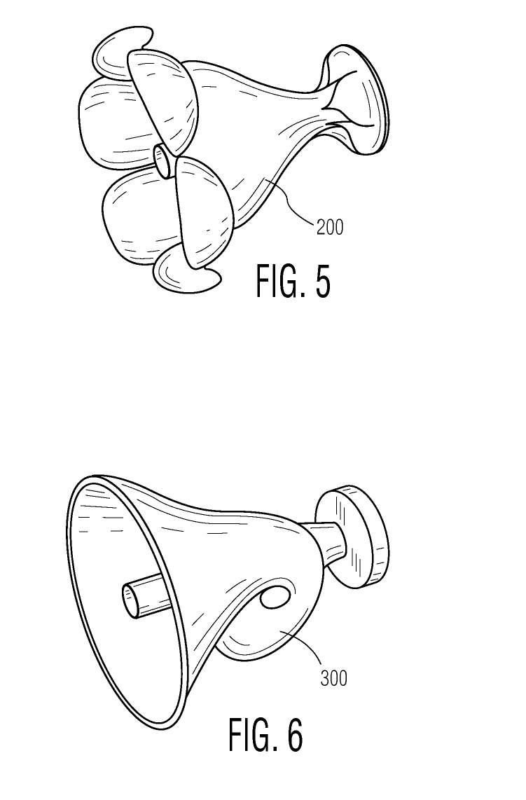

The filter 110 is preferably disposed within a straw section 140 that has an inlet 144 and an outlet 148, the inlet 144 receiving the filter 110 and the outlet 148 being positioned in the direction of the candle or candles to be extinguished (see FIG. 3). The outlet 148 is preferably hidden by the decorative cover 130, although it could preferably be flush with or extend slightly beyond the end of the decorative cover 130. A variety of filter constructions are contemplated, including a chemical cartridge filter or filters comprising charcoal, activated charcoal, wool, paper, plastic, glass, cellulose, or combinations thereof. The main function of the filter 110 is to remove or neutralize contaminants, particles, germs, bacteria, etc., from the air stream and the user so that a person using the extinguisher 100 to blow out the candles 700 on a birthday cake 800, for example, will not contaminate the cake 800 and perpetuate the spread of germs, disease, sickness, etc. The filter 110 is preferably designed to function in a single direction from the mouthpiece 120 to the outlet 148 of the straw section 140, although the filter medium should preferably not impede the air flow too much so that the user has to exert considerable force while blowing. In this regard, the straw section 140 is preferably between six and eighteen inches long to prevent a considerable reduction in blowing force at the outlet 148.

A sound generator or resonator 150 is preferably positioned in front of the filter 110 so that a user can make a pleasing sound or musical tune while using the extinguisher device 100. Of course, placement of the sound generator 150 would be acceptable anywhere along the user's blow path, i.e., from the mouthpiece 120 to the outlet 148 of the straw section 140. The sound generator 150 could be a separate element and attached to the filter 110 at the point of manufacture, or the sound generator 150 and filter 110 could be manufactured as a single, integrated component. The sound generator 150 is preferably inexpensive in the nature of a reed or whistle device, although more expensive options that require electronics or circuitry are certainly contemplated.

FIG. 2 illustrates one embodiment of an assembly of the extinguisher 100 of FIG. 1, with the straw section 140 attached to the decorative cover 130 and the filter section 110 attached between the decorative cover 130 and the mouthpiece 120. For example, the filter section 110 could be threaded to cooperatively mate with a threaded section on the straw inlet 144, while the sound generator 150 could have a similar mating relationship with the mouthpiece 120. Alternatively, all pieces of the extinguisher 100 could be attached by a force fit, or alternatively, by a more permanent fit created at the point of manufacture. The entire extinguisher 100 is preferably disposable and designed for a single use, and therefore the materials used to form the mouthpiece 120, decorative cover 130 and straw section 140 should be relatively inexpensive. For example, the straw section 140 could be formed from plastic, while the decorative cover 130 and mouthpiece 120 could be formed from plastic, paper, cardboard or combinations of the same. Other materials and constructions are contemplated.

One function of the decorative cover 130 is to provide a handgrip for the user during operation of the extinguisher device 100. The cover 130 could additionally be provided with a textured outer surface and/or molded finger portions (not shown), for example, to facilitate gripping. Furthermore, the cover 130 could be formed in a variety of shapes, sizes, colors, textures, materials, etc., to commemorate any occasion.

Operation of the extinguisher 100 is relatively straightforward and illustrated in FIG. 3. A user first places the extinguisher 100 in proximity to the candles 700 to be extinguished. Then the user places his/her mouth on the mouthpiece 120 and blows air through the opening 125 and through the filter 110 with the filtered air escaping through the outlet 148 until the candle or candles 700 is/are extinguished. During such time, the sound generator 150 generates a pleasing sound or musical tune such as, for example, the first couple of notes of “Happy Birthday” or the entire song for that matter. As the straw outlet 148 is relatively focused, the user may employ a sweeping motion while blowing as is traditional when trying to extinguish more than one candle. After all of the candles are extinguished, the extinguisher device 100 is discarded.

While the entire extinguisher device 100 is preferably discarded after a single use, a multi-use embodiment may be commercialized where only certain elements are disposable. For example, if the filter 110 is effective for up to ten uses, then it might be desirable to have only a disposable mouthpiece 120. Alternatively, both the mouthpiece 120 and the decorative cover 130 might be disposable if the type of filter used is comparatively expensive. A variety of disposable and non-disposable options are contemplated to address a particular environment, user, event or marketing price point.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A filtered cake candle extinguisher comprising:
a) a filter;
b) a mouthpiece connected to the filter; and
c) a decorative cover for covering at least the filter, the decorative cover connected to the mouthpiece.

2. The extinguisher of claim 1, wherein the mouthpiece is disposable.

3. The extinguisher of claim 1, wherein the support is a straw.

4. The extinguisher of claim 1, wherein the decorative cover is shaped like one of a cone, a flower or a musical instrument.

5. The extinguisher of claim 1, wherein the mouthpiece is shaped like one of a pair of lips, a star or a face.

6. The extinguisher of claim 1, further comprising a sound device that generates a sound when air passes therethrough.

7. The extinguisher of claim 6, wherein the generated sound is a musical tune.

8. The extinguisher of claim 7, wherein the filter is attached to the sound device.

9. The extinguisher of claim 6, wherein the filter is attached to the sound device.

10. The extinguisher of claim 1, wherein the filter is a chemical cartridge filter.

11. The extinguisher of claim 1, wherein the filter further comprises one of charcoal, activated charcoal, wool, plastic, glass, cellulose, or combinations thereof.

12. A method of blowing out a candle comprising:
a) providing a filter section connected to a mouthpiece, the filter section further comprising an outlet;
b) placing the outlet in proximity to the candle to be extinguished;
c) blowing through the mouthpiece and through the filter until the candle is extinguished.

13. The method of claim 12, further comprising providing a decorative cover for covering at least a portion of the filter section.

14. The method of claim 13, wherein the decorative cover is connected to the mouthpiece.

15. The method of claim 13, the filter section further comprising a filter body housed within a straw section.

16. The method of claim 15, further comprising a sound device connected to the filter section that generates a sound when air passes therethrough.

17. The method of claim 13, wherein the decorative cover is shaped like one of a cone, a flower or a musical instrument.

18. The method of claim 12, wherein the mouthpiece is shaped like one of a pair of lips, a star or a face.

19. The method of claim 12, further comprising discarding the mouthpiece after use.

20. The method of claim 13, further comprising discarding the mouthpiece and decorative cover after use.
